(19) United States
(12) Patent Application Publication
(10) Pub. No.: US 2010/0153578 A1
(43) Pub. Date: Jun. 17, 2010

(54) Method and Apparatus for Peer to Peer Streaming

(75) Inventors: Jozef Pieter Van Gassel, Tampere (FI); Imed Bouazizi, Tampere (FI); Igor Danilo Diego Curcio, Tampere (FI); Alex Ilmari Jantunen, Tampere (FI); Marko Antti Juhani Saukko, Tampere (FI); Lassi Ilari Vaatamoinen, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/503,640

(22) Filed: Jul. 15, 2009

Related U.S. Application Data
(60) Provisional application No. 61/081,359, filed on Jul. 16, 2008.

(51) Int. Cl. G06F 15/16

(52) U.S. Cl. 709/231

(57) ABSTRACT

In accordance with an example embodiment of the present invention, An apparatus, comprising a processor configured to assign at least one of a plurality of real time transport protocol data units to at least one of at least two peer to peer partial real-time transport protocol streaming sessions, based at least in part on at least one timestamp associated with the at least one of the plurality of real time protocol data units. The plurality of real time transport protocol data units, is associated with the real time transport protocol media stream.

### RELATED APPLICATIONS

This application claims priority to U.S. Application No. 61/081,359 filed on Jul. 16, 2008.

### TECHNICAL FIELD

The present application relates generally to streaming of data, or media, in a communication system.

### BACKGROUND

Peer-to-peer (P2P) is a content distribution solution in a communication network. It provides an alternative solution to the traditional client-server based approach. In a client-server based approach, centralized servers play an important role in the exchange of media content between different network entities, user terminals, and/or the like. In a P2P network, peer nodes or participants, may act simultaneously as both clients and servers. In a P2P network, peer nodes may be connected using ad hoc connections. An example application of P2P technology is file sharing.

In a communication network, media delivery methods comprise downloading, uploading, streaming, and/or the like. When using downloading or uploading, a receiving device may display the media content after the media transfer is completed. In the case of streaming, received media or data is usually displayed at the end-user device while the media is being delivered or before the transfer is complete. An end-user of a streaming application may avoid long start up delays since streaming eliminates the need to store the entire content on the user device.

Inspired by P2P file sharing technologies, real-time P2P streaming technologies are emerging as a new framework for streaming multimedia content.

### SUMMARY

Various aspects of the invention are set out in the claims.

In accordance with an example embodiment of the present invention, an apparatus, comprising a processor configured to assign at least one of a plurality of real time transport protocol data units to at least one of at least two peer to peer partial real-time transport protocol streaming sessions, based at least in part on at least one timestamp associated with the at least one of the plurality of real time protocol data units. The plurality of real time transport protocol data units, are associated with the real time transport protocol media stream.

In accordance with another example embodiment of the present invention, a method comprises assigning at least one of a plurality of real time transport protocol data units to at least one of at least two peer to peer partial real-time transport protocol streaming sessions, based at least in part on at least one timestamp associated with the at least one of the plurality of real time protocol data units. The plurality of real time transport protocol data units, are associated with a real time transport protocol media stream.

In accordance with an example embodiment of the present invention, an apparatus, comprising a processor configured to receive information related to at least two peer to peer partial real-time transport protocol streaming sessions. The at least two peer to peer partial real time transport protocol streaming sessions being associated with a real time transport protocol media stream. The processor is also configured to receive at least one of the at least two peer to peer partial real time transport protocol streaming sessions.

In accordance with another example embodiment of the present invention, a method comprises receiving information related to at least two peer to peer partial real-time transport protocol streaming sessions. The at least two peer to peer partial real time transport protocol streaming sessions being associated with a real time transport protocol media stream. The method also comprises receiving at least one of the at least two peer to peer partial real time transport protocol streaming sessions.

In accordance with another example embodiment of the present invention, a computer program product comprising a computer-readable medium bearing computer program code embodied therein for use with a computer, the computer program code comprises code for assigning at least one of a plurality of real time transport protocol data units to at least one of at least two peer to peer partial real time transport protocol streaming sessions, based at least in part on at least one timestamp associated with the at least one of the plurality of real time protocol data units. The plurality of real time transport protocol data units are associated with a real time transport protocol media stream.

In accordance with another example embodiment of the present invention, a computer program product comprising a computer-readable medium bearing computer program code embodied therein for use with a computer, the computer program code comprises code for receiving information related to at least two peer to peer partial real time transport protocol streaming sessions. The at least two peer to peer partial real time transport protocol streaming sessions are associated with a real time transport protocol media stream. The computer program code also comprises code for receiving at least one of the at least two peer to peer partial real time transport protocol streaming sessions.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example peer to peer network where embodiments of the invention may be implemented;

FIG. 2 depicts an overview diagram of an example peer to peer network with single source peer architecture;

FIG. 3 shows an overview diagram of an example clustered overlay architecture of a peer to peer network;

FIG. 4 is a block diagram illustrating partitioning of real-time transport protocol media streams into a plurality of partial real-time transport protocol media streams according to an example embodiment of the invention.

FIG. 5 is a diagram illustrating a process for partitioning a real-time transport protocol media stream into a plurality of partial real-time transport protocol streaming sessions according to an example embodiment of the invention;

FIG. 6 is a flow diagram of a method for partitioning a real-time transport protocol media stream into a plurality of partial real-time transport protocol streaming sessions according to an example embodiment of the invention;

FIG. 7 is a flow diagram of a method for receiving one or more partial real-time transport protocol streaming sessions according to an example embodiment of the invention; and

FIG. 8 is an overview diagram illustrating an example embodiment of the delivery of partial real-time transport protocol streams across multiple peers in a peer to peer network.

### DETAILED DESCRIPTION OF THE DRAWINGS

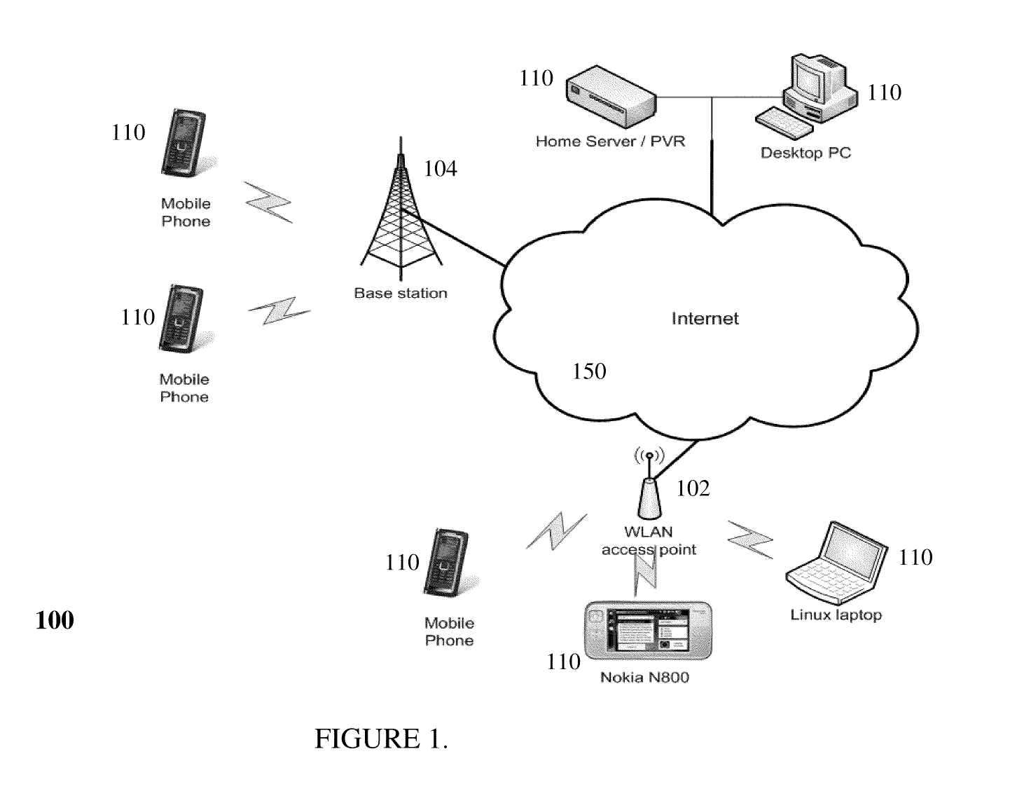

An example embodiment of the present invention and its potential advantages are best understood by referring to FIGS. 1 through 8 of the drawings.

FIG. 1 illustrates an example peer to peer network 100 where embodiments of the invention may be implemented. The peer to peer network 100 comprises a plurality of peers, or peer nodes, 110. A peer 110 may be a desktop computer, a laptop computer, a server, a mobile device, and/or the like. A peer 110 may be coupled to one or more other peers 110. Peers 110, in peer to peer network 100, may be coupled to one another, for example, through one or more communication networks comprising, for example, a local area network (LAN), Internet 150, a wireless communication network, and/or the like. A peer 110, or user equipment (UE), may have access to the Internet 150 through a wireless local area network access point 102, a wireless network base station 104, a wired local area network (LAN) access point, and/or the like. Couplings between peers in a P2P network 100 are established at the application layer.

P2P technology is gaining popularity as a framework for real-time streaming of multimedia content. Real-time P2P streaming may enable new use cases and business models for end-users, network providers, and/or the like. P2P streaming technology allows streaming of multimedia content by an end-user, to one or more other users, in real-time without the need for dedicated servers, e.g., streaming servers. Multimedia content may be streamed to an end-user device, or a consuming peer 110 through one or more other peers 110. In a peer to peer network 100, content delivery may be managed by the peers 110 without a dedicated server, for example, to setup, manage and/or maintain communication channels and/or transfer data associated with a multimedia streaming application.

The communication resources of a P2P network 100 are usually distributed over multiple peer nodes 110. Real-time P2P streaming technology is inherently scalable allowing, for example, a large amount of multimedia content and a large number of content providers, e.g., end-users. Real-time P2P streaming may also have the potential to support broadcasting applications since any peer 110 in a peer to peer network 100 may become an independent broadcaster.

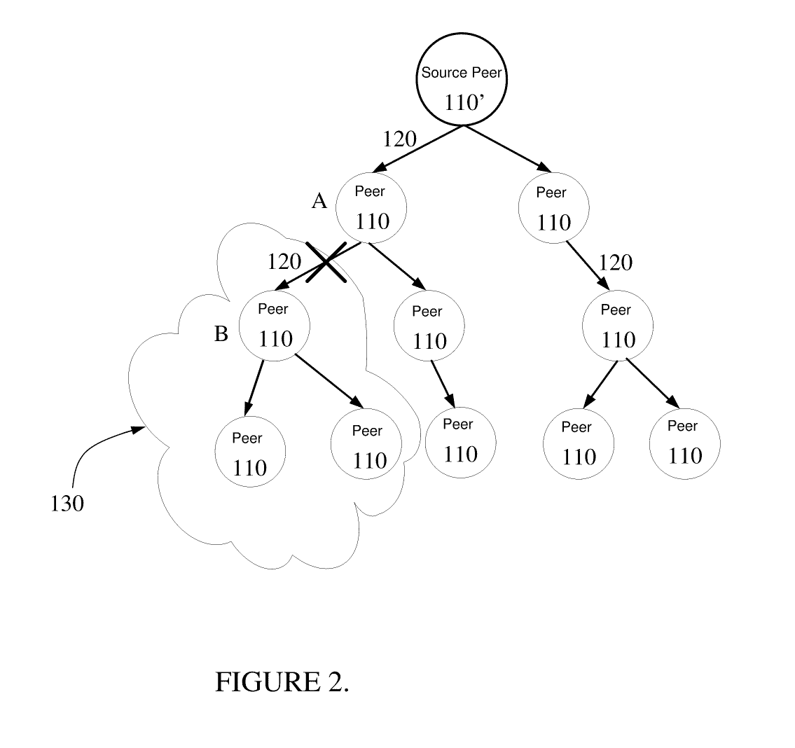

FIG. 2 depicts an overview diagram of an example peer to peer network 100 with single source peer architecture. The example architecture has a tree structure, with a primary source peer 110′. The primary source peer 110′ is the original source of media content delivered to other peers 110. A consuming peer 110 receives the media content and consumes it, for example, displays it to an end-user. An intermediate, or forwarding, peer 110 receives media content and forwards it to another peer 110. A forwarding peer 110 may also be a consuming peer 110. For example, a forwarding peer may forward the media content to other peers 110 and also display it, to its corresponding end-user. In the example architecture described in FIG. 2, each peer 110 receives media content from a single source peer. A source peer may be a primary source peer 110′ or a forwarding peer 110.

In an architecture characterized by single source peer, the risk of interruptions in data transfer may increase. In FIG. 2, an interruption in data transfer, for example, across a link 120 between a peer A and a peer B, affects a group, or subtree, 130 of peers associated with peer B. In other words, as peer B experience the interruption in data transfer, so do peers 110 that are subordinate to peer B, e.g., child peers associated with peer B.

P2P streaming may present new challenges to existing content distribution mechanisms and protocols. For example, peers 110 may dynamically join and/or leave a P2P network 100. A peer 110 may receive streaming data from one or more source peers 110. If one or more source peers leave the P2P network 100, the receiving peer 110 may need to re-select its corresponding source peers 110. A peer 110 may have uplink bandwidth, used to transmit media content to one or more other peers 110, and/or downlink bandwidth, used to receive media content from one or more other peers 110. A peer 110 may have an asymmetric access network connection, e.g., with uplink bandwidth different from downlink bandwidth. Some peers 110 may not, for example, have enough uplink bandwidth to serve another peer 110 with a complete data stream, e.g., a video stream. Another example of a challenge associated with real-time P2P streaming is delay constraint on session start-up. Users of P2P streaming applications may not be tolerant to very long start-up delays, for example, in the range of one or more minutes. Long time delays, when starting a P2P streaming session, may degrade quality of user experience.

The start-up delay may be affected, at least in part, by the number of hops, or connection links 120, between a source peer 110′ and a consuming peer 110. The number of hops between a source peer 110′ and a consuming peer 110 may be large, for example, in a P2P network 100 with single source peer architecture.

P2P file sharing applications make use of a content distribution approach with multiple source peers. A file is first partitioned into pieces or chunks, for example, of equal size. A peer connects to source peers and requests missing pieces of the file in a random order. The process of downloading of file pieces may be slow and users may experience long download delays, for example, of several days. In streaming applications, however, long delays may not be acceptable.

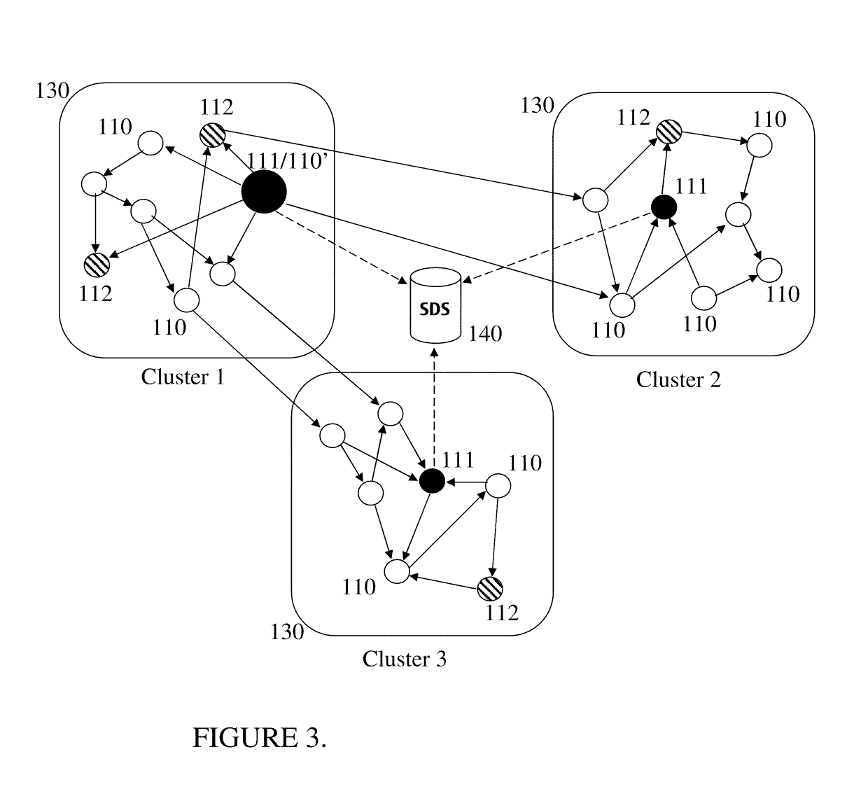

FIG. 3 shows an overview diagram of an example clustered overlay architecture of a peer to peer network 100. A P2P network 100 with clustered overlay architecture is an example P2P network where example embodiments of the invention may be implemented. The example overlay network in FIG. 3 comprises three clusters 130, for example cluster 1, cluster 2, and cluster 3, associated with a P2P service. According to an example embodiment of the invention, an overlay network is maintained separately for each P2P service, or application, e.g., a real-time transport protocol (RTP) media streaming session. A service discovery server (SDS) 140 may comprise information about hierarchy of one or more clusters 130. SDS 140 may also comprise information on available P2P services in a communication system. In an example embodiment, SDS 140 may be a central non-mobile server that is not part of the actual P2P overlay network. In an alternative embodiment, the SDS 140 may be implemented in a distributed manner, e.g., by using Distributed Hash Tables (DHTs).

A cluster 130 comprises a plurality of peers 110. A cluster 130 may be managed and/or maintained by a cluster leader (CL) 111. In an example embodiment, one CL 111 is assigned to each cluster 130. One or more backup cluster leaders (BCLs) 112 may also be assigned to each cluster 130. CLs 111 may manage peers 110 inside the cluster 130. For example, a CL 111 may assist a new joining peer 110 to couple, or connect, to one or more other peers 110 in the cluster 130. A CL 130 may be, for example, a mobile peer node with capabilities such as a high throughput access network connection, large memory, high CPU power, long expected battery lifetime, and/or the like. A CL may also be a fixed peer node, e.g., a desktop computer, in the P2P network 100.

According to an example embodiment of the invention, a peer 110 may perform periodic keep-alive messaging with the CL 111 and other peers 110, e.g., from which it receives or received RTP packets. A peer 110 may use keep-alive messaging to inform other peers 110 of its existence. In other words, keep-alive messaging allows peers to keep track of the status of other peers, e.g., whether other peers have left, or are still coupled to, the P2P network 100. The RTP may use user datagram protocol (UDP) and may not inform a source peer, for example, whether or not a receiving peer, e.g., peer 110, is still in the P2P network 100. However, the source peer may detect, the departure of a receiving peer 110 from the P2P network 100, for example, based on an interruption of keep-alive messages from the receiving peer 110. A source peer may then avoid unnecessary data transmission, e.g., to a receiving peer 110 that has left the P2P network 100.

According to an example embodiment of the invention, the P2P network 100 with clustered overlay architecture is scalable with the clusters 130 grouping the peers 110 based at least in part on their proximity. For example, when joining a P2P network 100, a peer 110 may select the CL 111 that is closest, e.g., to the joining peer 110. The selection of the closest CL 111 may be based on the joining peer's 110 best knowledge of locality, e.g., using round trip time (RTT) values between the joining peer 110 and one or more CLs 111. In an example embodiment of the invention, clusters 130 may be divided into different layers in order to improve cluster search performance, e.g., O(log(n)) instead of O(n), especially when the number of clusters is large. According to an example embodiment of the invention, the number of peers 110 in a cluster 130 may be limited or upper bounded. Limiting the number of peers 110 in a cluster 130 may prevent large processing overload on CLs 111. The scalability of the overlay P2P network may be sustained without degrading P2P service. For example, the clustered overlay P2P network may expand by creating new clusters 130 and preventing existing clusters 130 from expanding beyond a limit, e.g., an upper bound on the number of peers 110 in each cluster 130.

According to an example embodiment of the present invention, in a P2P multimedia streaming session, media content associated with a media stream, is compressed into real-time transport protocol (RTP) data units, or packets. A media stream, or RTP session, may be partitioned, or split, into at least two partial RTP streams, for example, at a primary source peer 110′. According to an example embodiment of the invention, the partitioning of a RTP session, into partial RTP streams, may be performed at the RTP data packets level. One or more peers 110 may request to receive one or more partial RTP streams. Partial RTP sessions are set-up for streaming RTP data units associated with partial RTP streams.

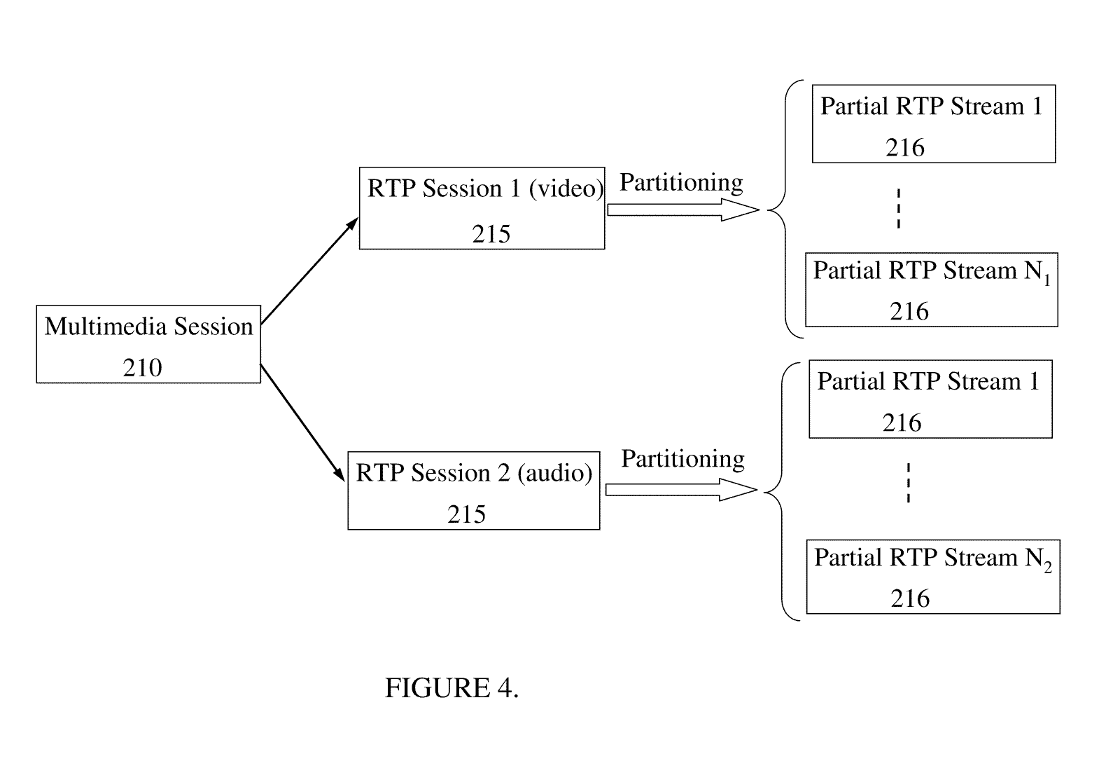

FIG. 4 is a block diagram illustrating partitioning of real-time transport protocol media streams 215 into partial real-time transport protocol media streams 216 according to an example embodiment of the invention. A multimedia session 210 may comprise one or more RTP sessions 215 or media streams. In FIG. 4, the multimedia session 210 comprises video and audio RTP sessions. In the block diagram of FIG. 4, each of the two RTP sessions, e.g., audio and video, 215 is partitioned into a plurality of partial RTP streams. The video session is partitioned, for example, into N₁ partial RTP streams 216 and the audio session is partitioned, for example, into N₂ partial RTP streams 216. N₁ and N₂ are integer numbers larger than or equal to one. In an example embodiment of the invention, partitioning of media streams 215 into a plurality of partial real-time transport protocol media streams 216 may be performed by a primary source peer 110′, or another peer 110 in the P2P network.

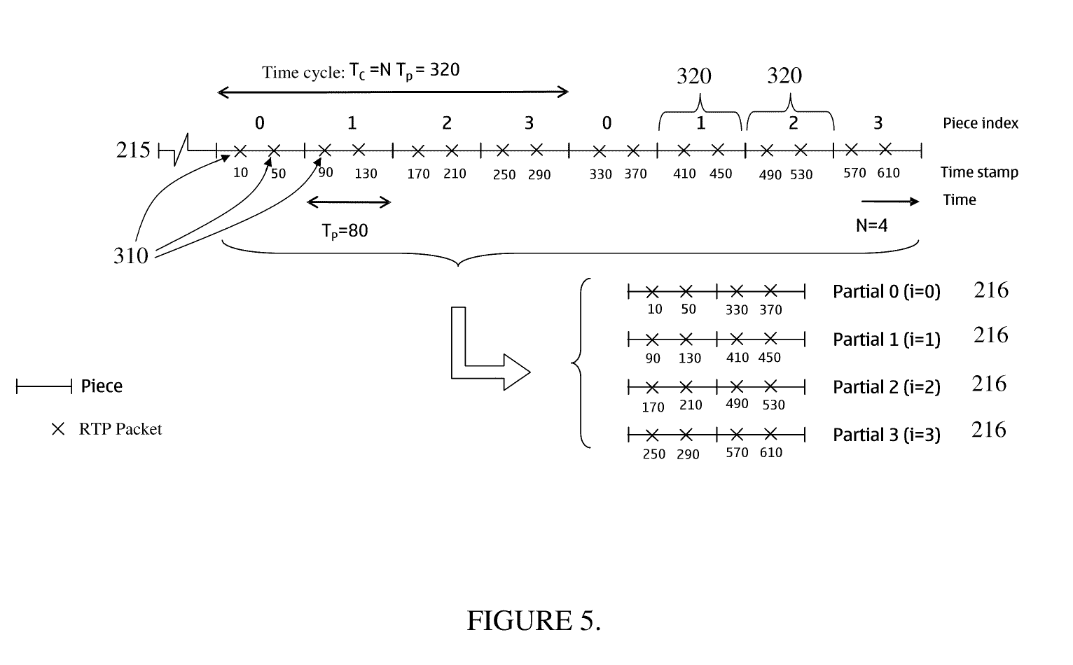

FIG. 5 is a diagram illustrating a process for partitioning a real-time transport protocol media stream 215 into a plurality of partial RTP streaming sessions 216 according to an example embodiment of the invention. A RTP session, or stream, 215, e.g., video, audio, subtitle streams, and/or the like, may be split, or divided, into partitioned pieces 320, for example, along a time axis. In an example embodiment, each of the partitioned pieces 320 may have a fixed time duration Tₚ. If desired, the partitioned pieces 320 may have different time durations. In the example embodiment of FIG. 5, each partitioned piece 320 may correspond to one or more RTP data packets, or units, 310. In an example embodiment of the invention, the time duration Tₚ of a partitioned piece 320 may be selected in such a way that it is large enough to contain at least one RTP packet 310 on average. In the example embodiment of FIG. 5, the time duration of the partitioned is equal to 80 milli-seconds (ms), e.g., T_{P}=80 ms. Each partitioned piece 320 comprises two RTP data packets 310. For a video stream with a frame rate equal to 25 frames per second, each partitioned piece 320 carries media data corresponding to two picture frames. For example, the same video stream, a partitioned piece 320 with time duration equal to 400 ms carries media content corresponding to 10 picture frames. The partitioned pieces 320, of the RTP session 215, are demultiplexed into N partial RTP streams, or sessions, 216. N is the total number of partial RTP streams, or sessions 216. In FIG. 5, N is equal to 4.

According to the example embodiment of FIG. 5, the time period, or time cycle, to assign one partitioned piece 320 to each partial RTP stream 216 may be defined as T_{c}=N×Tₚ. In an example embodiment, the partitioned piece time duration T_{P} may be selected in such a way that it is large enough to comprise at least one RTP data packet 310 on average. If the time duration Tₚ is very small, some partitioned pieces 320 may be empty, e.g. with no data. Occurrence of a plurality of empty partitioned pieces 320 may lead to an empty partial stream 216. Large cycle times, however, may lead to long start-up delays. A consuming peer 110 may buffer a complete cycle, for example N partitioned pieces 320, before seamless playback may start. In an example embodiment, the total number N of partial RTP streams may be between 4 and 10.

In an example embodiment of the invention, every partitioned piece 320 may start with an intra-coded picture in order to facilitate independent decoding of partial RTP streams or sessions 216, for example, in the presence of packet loss due to a partial RTP stream 216 not being received. Aligning pardoned pieces 320 with group-of-picture (GOP) boundaries may result in having an intra coded picture at the start of each partitioned piece 320.

A RTP data unit, or packet, 310 carries time information, e.g., timestamp (t_{RTP}), indicating sampling instant of first octet of the same RTP data unit 310 within the corresponding RTP session 215. In an example embodiment, partitioned pieces 320 may have a time reference t₀ aligned with RTP time reference, or origin of RTP time line. The origin of the RTP time line may be the playback time, or timestamp, of first RTP data packet 310 in the RTP stream 215. In other words, the start of the first pardoned piece 320 may be located at the origin of the RTP time line. In an alternative embodiment, the origin of the first partioned piece 320 may be located at any arbitrary point on the RTP time line. In case there is an offset between the origin of RTP timeline and the origin of the first partitioned piece 320, a signalling of the start time, e.g., representing the time when the streaming service is started, may be used. In an example embodiment, the origin of the stream may be signalled from a primary source peer 110′ to other peers 110 using RTP-Info header of a RTSP PLAY response message. In another example embodiment, the origin of the stream may be indicated in a media session description, e.g., session description protocol (SDP) or a torrent file. A source peer may signal an offsetted origin to the connecting peers 110.

Table I lists a set of parameters associated with FIG. 5.

TABLE I
Parameters associated with partial RTP streams or sessions.

| Parameter | | |
|---|---|---|
| Symbol | Parameter Name | Parameter Description |
| T_{P} | Partitioning piece | Size of the smallest partitioning |
| | size/duration | piece in terms of time of an RTP |
| | | session |
| t₀ | RTP time origin | Represents the origin of the RTP time |
| | | line |
| t_{RTP} | RTP time stamp | Denotes the RTP timestamp carried in |
| | | the RTP data packet |
| N | Number of partial | Determines in how many partials an |
| | streams | RTP session is subdivided |
| i | Partial stream index | The index of the partial stream |
| | | (where 0 <= i < N) |

According to the example embodiment of FIG. 5, a RTP data unit, or packet, 310, with timestamp value t_{RTP}, may be assigned to a partial RTP streams 216 with index i, is using the equation below;

$$i = round ( \frac{{t}_{RTP} - {t}_{0}}{{T}_{P}} ) mod N .$$

The operator “mod” represents the mathematical modulo operation. In an example embodiment of the invention, every RTP data packet 310, in the RTP media session 215, is assigned to a partial RTP stream 216 using the RTP timestamp t_{RTP}, the time duration T_{P} of a partioned piece 320, the total number of RTP partial streams 216 N, and the parameter t_{O}.

One of the benefits of defining partitioning pieces 320 based on time duration, e.g., playback time duration, may be that all packets may remain intact at the RTP layer. For example in video streaming, different RTP data packets 310 may correspond to content associated with different picture frames. In an example embodiment where the partitioning piece duration T_{P} is set as a multiple of playback duration of one picture frame, each partitioning piece 320 comprises an integer number of RTP data packets. Partial RTP streams 216 may then be created, or generated, at the level of RTP data packets 310, therefore avoiding any segmentation of RTP data packets 310. Segmentation of RTP data packets 310, when creating partial RTP streams 216, may significantly increase the complexity of the implementation.

In one aspect of the invention, enhanced robustness may be achieved by assigning key RTP packets 310 to more than one partial RTP stream 216. Key RTP packets comprise RTP packets corresponding to, for example, intra coded picture data in video content, or other data that may help error concealment. Duplicate RTP packets may be removed upon reception.

A peer 110 may request the delivery of one or more partial streams from another peer 110. In an example embodiment, a partial stream is the finest granularity for media streaming. Thus in an example embodiment, a peer may not stream a fraction of a partial RTP stream 216. In an alternative embodiment, a fraction of a partial RTP stream may be streamed. The number of partial RTP streams 216 may be tuned to achieve the target bitrate of a partial RTP stream. It is desirable that each peer 110 in the P2P network 100 has enough uplink bandwidth to stream at least a single partial RTP stream. Compressed video content typically has variable bitrate, for example, an instantaneous decoder refresh (IDR), e.g., intra-coded, picture may result in more bits than an inter-coded picture. In an example embodiment of the invention, selection of the partitioning parameters, e.g., N and/or Tₚ, may be done in a way to avoid un-balanced partitioning. Unbalanced partitioning may happen if, for example, IDR pictures, which are significantly larger in size than other pictures fall into the same partial RTP stream 216. If desired, RTP data packets corresponding to IDR pictures may be assigned to the same partial RTP stream.

The number of partial RTP streams 216, N, may vary per RTP session 215. For example, if the bit rate of a RTP audio session 215 is already in the order of magnitude of a single partial RTP video stream, the RTP audio stream 215 may not be partitioned into partial RTP streams 216.

The number of partial RTP streams 216, N, may not be constant throughout the P2P network 100 of a P2P service. In an example embodiment, N may be changed at one or more forwarding peers 110 in the network. N may be determined depending on local metrics such as the available uplink and downlink bandwidths. However, choosing the same N throughout the network simplifies the design of the partitioning functionality.

According to an example embodiment of the invention, a single source peer may send multiple partial RTP streams 216 to a particular receiving peer. The multiple partial RTP streams may be streamed in a single RTP session 215 or in separate RTP sessions 215.

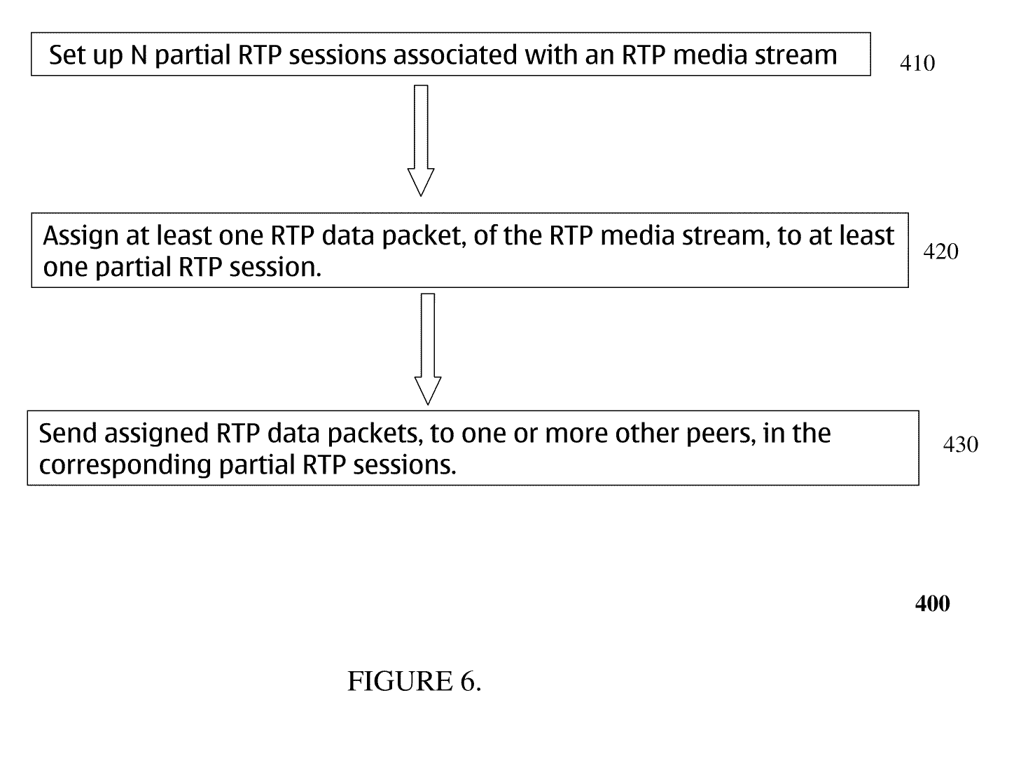

FIG. 6 is a flow diagram of a method 400 for portitioning a real-time transport protocol media stream 215 into a plurality of partial RTP streaming sessions 216 according to an example embodiment of the invention. At block 410, at least two partial RTP sessions 216 associated with a media RTP stream 215 are set up, for example, by a primary source peer 110′. Setting up partial RTP sessions 215 may comprise one or more of; determining the number of partial RTP sessions 216, e.g., N, transmitting parameters associated with the partial RTP sessions 216 to one or more other peers 110, receiving requests from one or more other peers 110 requesting to receive at least one partial RTP session, or stream, 216, and sending response messages to the received requests. In an example embodiment, one or more peers 110, may send requests, to the primary source peer 110′, for one or more partial RTP streams 216. The requests may comprise indication of the requested partial RTP streams, e.g., indices of partial RTP streams. The primary source peer 110′ may respond with an acknowledgement of the requests.

At block 420, at least one RTP data packet 310, of the RTP media stream 215, is assigned to at least one partial RTP session 216, for example by a primary source peer 110. According to an example embodiment of the invention, the assignment of RTP data packets 310 may be done according to the partitioning process, or procedure, described with reference to FIGS. 4 and 5.

At block 430, assigned RTP data packets 310 are transmitted, or sent, within their corresponding partial RTP session 216. For example, a peer 110 in the P2P network 100 may request one or more partial RTP streams 216. The one or more partial RTP streams 216 are transmitted to the requesting peers, for example by the primary source peer 110′.

According to an example embodiment of the invention, an apparatus, e.g., a primary source peer 110′, may comprise a memory unit to store media data associated with one or more RTP streaming sessions 215 of a multimedia streaming session 210. The apparatus may also comprise a processor configured to perform the method described in FIG. 6. Examples of the apparatus comprise a mobile device, a laptop computer, a desktop computer, and/or the like. The apparatus may also comprise encoding modules to encode the media content into compressed form(s).

According to an example embodiment of the invention, the method described in FIG. 6 may be implemented as a program computer code embodied in in a computer-readable medium.

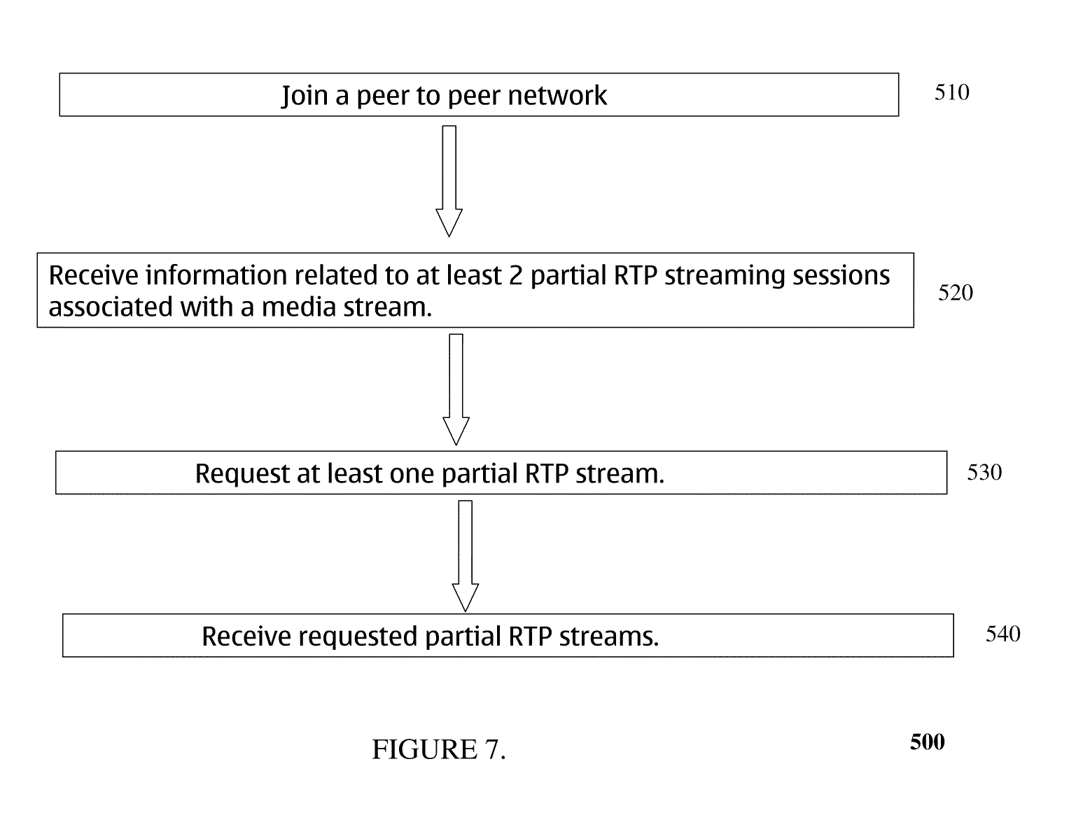

FIG. 7 is a flow diagram of a method 500 for receiving one or more partial RTP streaming sessions 216 according to an example embodiment of the invention. At block 510, a peer node, for example peer node 110, joins a P2P network, e.g., P2P network, 100 associated with a P2P streaming service, or application. At block 520, the peer node 110 receives information related to at least two partial RTP sessions 216 associated with a RTP media stream, or session 215. In an example embodiment, the information is a notification comprising one or more parameters related to the partial RTP streams 216, e.g., number of partial RTP streams, duration of partitioned piece 320, and/or the like. In an example embodiment, the notification is received from a source peer, a primary source peer 110′, CL 111, SDS 140 and/or the like. At block 530, the peer node sends at least one request, to at least one other peer 110, for at least one partial RTP stream, or session, 216. The requesting peer 110 may also receive a response to its request(s). At block 540, the peer receives the requested partial RTP session(s), or stream(s) 216. In an example embodiment, the peer may also receive messages(s) from one or more other peers 110, for example, requesting forwarding of one or more of the partial RTP sessions received by the peer 110. In such a case, the peer node may transmit, or forward, the requested partial RTP session(s), or stream(s), 216 to the one or more requesting peers 110. The peer node may also reconstruct the RTP media stream from the received partial RTP media streams and consumes the constructed RTP media stream.

According to an example embodiment of the invention, a peer 110, performing the method described in FIG. 7, is an apparatus comprising a memory unit to store, for example, RTP data packets 310 associated with one or more partial RTP streaming sessions 216. The apparatus also comprises a processor configured to perform the method described in FIG. 7. Examples of the apparatus comprise a mobile device, a laptop computer, a desktop computer, and/or the like. The apparatus may also comprise encoding modules to encode the media content into compressed form(s).

According to an example embodiment of the invention, the method described in FIG. 7 may be implemented as a program computer code embodied in in a computer-readable medium.

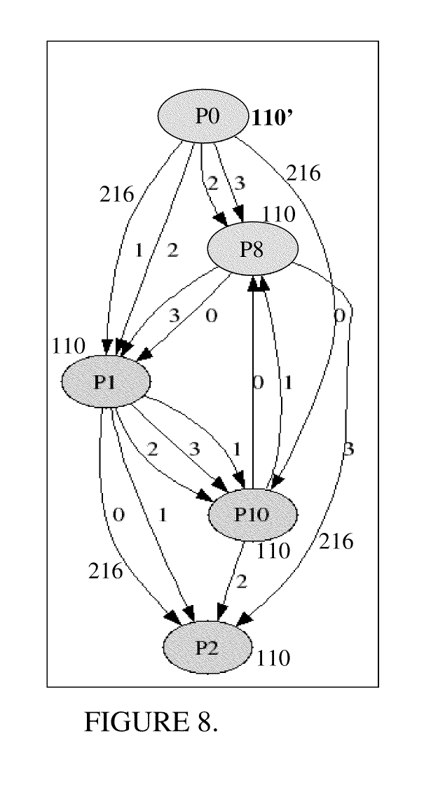

FIG. 8 is an overview diagram illustrating an example embodiment of the delivery of partial real-time transport protocol streams 216 across multiple peers 110 in a peer to peer network 100. The nodes in FIG. 8 represent peers 210 and the edges represent partial RTP streams 216. Partial RTP streams' indices i are indicated next to each edge. The number of partial streams, N, is set to four. The source peer P0 in the graph, e.g., the source of the streaming service, is sending data to peers P1, P8 and P10. Peer P0 is sourcing partial RTP streams 1 and 2 to P1 and partial RTP streams 2 and 3 to P8 thereby effectively doubling the upload bit rate between peers P0 and P2.

In an example embodiment of the invention, special extensions to RTSP may be defined for setting up streaming of partial RTP streams 216. For example, the extensions may be used to signal partial RTP stream parameters from one peer 110 to another peer 110. Setting up of partial RTP streams 216 may be done with RTSP methods such as SETUP and PLAY. The SETUP method is extended to include the additional “P2P-Extension” feature tag in the “Require” header field. This feature tag makes it possible for a receiving peer 110 to detect that support for P2P extensions may be required. Example syntax for such a message is shown below:

| | |
|---|---|
| Peer1−> | SETUP rtsp://x.y.z.w/audio RTSP/1.0 |
| Peer2: | CSeq: <#> |
| | Require: P2P-Extension |
| | Transport: |
| | AVP/RTP;unicast;client_port=<streamport>-<controlport> |
| Peer2−> | RTSP/1.0 200 OK |
| Peer1: | CSeq: <#> |
| | Transport: AVP/RTP;unicast;client_port=<streamport> |

The RTSP PLAY syntax may be extended as follows:

| | |
|---|---|
| Peer1−> | PLAY rtsp://x.y.z.w/audio RTSP/1.0 |
| Peer2: | CSeq: <#> |
| | Require: P2P-Extension |
| | Partial_Stream: |
| | piecesize_in_msec=<#>;modulo=<#>;remainder=1,3,#,... |
| Peer2−> | RTSP/1.0 200 OK |
| Peer1: | CSeq: <#> |
| | Partial_Stream: |
| | piecesize_in_msec=<#>;modulo=<#>;remainder=1,3,#,... |
| | RTP-Info: url=”rtsp://x.y.z.w/audio” rtptime=6030 |

The parameter t₀ may be optional, and so the RTP-Info header field in the example above may also be optional.

According to an example embodiment of the invention, clustered overlay P2P network operations may be implemented using an extended real time streaming protocol RTSP. RTSP methods may be extended to comprise one or more additional feature tags related to real-P2P extensions. For example a tag, e.g., ‘RTP2P-v1’ may be used in the ‘Require’ header field, to indicate support of RTSP extensions associated with real-time P2P applications and/or P2P network. In an example embodiment, this feature tag, i.e., ‘RTP2P-v1’, makes it possible for the receiving peer to detect that support for the real-time P2P extensions is desired. RTSP messages may also comprise a header field associated with peer identification (PID), e.g., a ‘Peer-Id’ header field. The header field associated with PID may indicate the source of the message comprising the header field associated with PID, e.g., an identification of the source peer. Other additional header fields may be added depending on the type of message.

When a peer 110 wants to join the P2P overlay network a peer identifier (PID) may be requested from SDS 140. The request for the peer identifier (PID) may be performed using an OPTIONS RTSP message. The OPTIONS RTSP message may comprise a tag indicating PID, e.g., ‘NewPeerld’, in a header field of the OPTIONS RTSP message, e.g., ‘Cluster’ header field. Before receiving PID, the peer may set the value of PID to −1 in the OPTIONS RTSP message. A response message comprising a unique PID is returned by SDS 140. In an example embodiment, the response message may be a 200 OK RTSP message with a header field associated with PID, e.g., ‘New-Peer-Id’ header field. In an example embodiment, the PID may be an unsigned integer value. The value zero may be reserved for the SDS 140. Examples of the OPTIONS and 200 OK RTSP messages are shown below.

OPTIONS * RTSP/1.0
CSeq: 763332
Require: RTP2P-v1
Cluster: NewPeerId
Peer-Id: −1
RTSP/1.0 200 OK
CSeq: 763332
New-Peer-Id: 430
Peer-Id: 0

When joining a selected cluster 130, a peer may receive an initial list of potential source peers, e.g., peers 110 from which media data may be acquired. In an example embodiment, the initial list is received from CL 111 of the selected cluster 130. According to an example embodiment of the invention, CL 111 may send only a subset of peers 110, for example if the number of peers 110 in the cluster 130 is large. If desired, CL 111 may send a comple list of peers in the selected cluster 130. CL 111 may also add new peers 110 joining the cluster 130 to its peer list. According to another example embodiment of the invention, proximity testing in source peer selection, e.g., within a selected cluster 130, may be optional since cluster selection procedure may guarantee that peers 110, within a cluster 130, are close to each other. If desired, the joining peer 110 may test selected source peers, for example, until suitable ones are found. The joining peer may also receive updates of the list of potential source peers while performing periodical keep-alive messaging. Thus, in an example embodiment, the list of potential source peers, for a peer 110 consuming a P2P service, may then be kept up-to-date during the service.

According to an example embodiment of the invention, SDS 140 is informed of CL 111 creation, departure and/or change by sending an OPTIONS RTSP message, to SDS 140. The OPTIONS RTSP message comprises a tag, e.g., ‘update’, in the ‘Cluster’ header field. The OPTIONS RTSP message with the ‘update’ tag allows maintaining an up-to-date cluster 130 list at SDS 140. In an example embodiment, the CL 111 is a functional entity in the network and may also participate as a peer 110 at the same time, e.g., by receiving and sending media data. Below is an example of OPTIONS and 200 OK RTSP messages used for cluster update;

OPTIONS rtsp://192.168.0.1:8554/128 RTSP/1.0
CSeq: 974155
Require: RTP2P-v1
Cluster: update
Cluster-Id: 0
Content-Length: 381
Content-Type: text/xml
Old-Peer-Id: 702
Client-Port: 8555
Peer-Id: 702
<cluster clusterId=“0”>
<clusterLeader peerId=“702” ipAddress=“192.168.0.2” port=“8555”
joinTime=“1213727001” />
<bclList>
<peer peerId=“706” ipAddress=“192.168.0.3” port=“8555”
joinTime=“1213727023”
/>
</bclList>
<neighborList>
<cluster clusterId=“1”>
<clusterLeader peerId=“703” ipAddress=“192.168.0.4” port=“8555”
joinTime=“1213727086” />
</cluster>
</neighborList>
</cluster>
RTSP/1.0 200 OK
CSeq: 974155
Peer-Id: 0

According to example embodiment of the invention, a peer 110, or a primary source peer 110′, may create a P2P service by sending an ANNOUNCE RTSP message to the SDS 140. An example of ANNOUNCE RTSP message describing a live streaming service is shown below;

ANNOUNCE rtsp://192.168.0.1:8554 RTSP/1.0
CSeq: 763334
Require: RTP2P-v1
Content-Length: 572
Content-Type: application/sdp
Client-Port: 8555
Peer-Id: 430
v=0
o=430 0 2 IN IP4 192.168.0.2
s=Live Streaming
c=IN IP4 0.0.0.0
t=0 0
a=service-type:live
m=video 8234 RTP/AVP 96
a=rtpmap:96 H264/90000
a=fmtp:96 packetization-mode=1;profile-level-id=42c033;
sprop-parameter-sets=Z0LAM6tBYnf+AXwBBiAAAAMAIAAABJHjBlQ=,aM48gA==;
a=partial-info:stream-id=1;piece-size=400;nb-of-partials=4;
m=audio 3456 RTP/AVP 97
a=rtpmap:97 mpeg4-generic/16000
a=fmtp:97 streamtype=5; profile-level-id=15; mode=AAC-hbr; config=1410;
SizeLength=13;IndexLength=3; IndexDeltaLength=3; Profile=1;
a=partial-info:stream-id=0;piece-size=100;nb-of-partials=1;

In the example ANNOUNCE RTSP message, a ‘Client-Port’ header field indicates the port number to be used in the overlay communication. The service is described using the session description protocol (SDP). Two SDP attributes, ‘service-type’ and ‘partial-info’ may be used to signal the service information. The ‘service-type’ attribute defines the type for the service. The ‘partial-info’ attribute may comprise an identifier for the RTP streaming session and parameters associated with partitioning of RTP session.

As a response to an ANNOUNCE RTSP message a 200 OK RTSP message may be sent by the SDS 140. The 200 OK RTSP message comprises ‘Cluster-Id’ and/or ‘Service-Id’ header fields to describe IDs for the initial cluster and the newly created service, respectively. A 301 Moved Permanently response message may also be sent, for example, to the creating peer, if the SDS 140 has been moved to another location. In a redirection case, a ‘Location’ header may be used to inform the creating peer about the new location of SDS 140. Receiving any other message type, e.g., not the 200 OK RTSP message may be interpreted as a failed P2P service creation. The 200 OK RTSP message sent by SDS 140 may be interpreted as the P2P service is successfully created. An example 200 OK RTSP message sent as a response to a session creation request is shown below;

RTSP/1.0 200 OK
CSeq: 763334
Cluster-Id: 0
Service-Id: 87
Peer-Id: 0

For a successfully created P2P service, an initial cluster 130 may be created by selecting a CL 111. In an example embodiment, a first peer joining the service may be assigned to be a CL 111 by the SDS 140. According to another example embodiment, the original data source, e.g., primary source peer 110′, may be the first CL 111 in the service. The CL 111 may wait for other peers 110 to join the service. As new peers join the service, BCLs 112 may be assigned by the CL 111. In an example embodiment, the assignment of BCLs 112 may be achieved with an OPTIONS RTSP message with, for example, ‘backup’ tag in the ‘Cluster’ header field. If a peer accepts the BCL assignment it may send a 200 OK message. If a peer does not accept the BCL assignment, it may send a 403 Forbidden message. Example messages sent in a successful BCL assignment are shown below.

OPTIONS rtsp://192.168.0.3:33854/87 RTSP/1.0
CSeq: 53559
Cluster: backup
Cluster-Id: 0
Peer-Id: 430
Require: RTP2P-v1
RTSP/1.0 200 OK
CSeq: 53559
Client-Port: 8555
Peer-Id: 432

If a CL 111 is leaving the P2P network it may be replaced by one of the BCLs 112, in the same cluster 130 as the CL 111. In an example embodiment, in a cluster 130 without an active CL 111, new peers may not be accepted into the cluster 130. Peers 110 in a cluster 130 may not be able to discover new peers 110 joining the same cluster 130 during the CL change. BCL 112 may send a GET_PARAMETER request message to CL 111. If BCL does not receive a response from CL 111 it may conclude that the CL 111 has left the cluster 130. The BCL may contact SDS 140 using an OPTIONS message requesting to replace the CL 111. In case there is more than one BCL 112 in a cluster, the BCL whose OPTIONS message is received first may be assigned as the new CL 111. Peers joining the cluster may use the new assigned CL 111. Other BCLs 112, in the cluster 130, may receive a 301 Moved Permanently message comprising information about the new assigned CL 111. The other BCLs may send an OPTIONS message with, for example, a ‘join_bcl’ tag in the ‘Cluster’ header field to the new assigned CL 111 and keep the BCL role. If the old CL 111 has not left the cluster 130 but has had connectivity issues, the OPTIONS message may be redirected to the new CL 111 by the SDS 140. The old CL 111 may become a BCL 112, according to an example embodiment. Example messages sent in the CL 111 replacement are shown below;

GET_PARAMETER rtsp://192.168.0.2:8555/87 RTSP/1.0
CSeq: 1470401
Require: RTP2P-v1
Leader-DB-Version: 2
Neighbor-DB-Version: 2
Peer-Id: 432
OPTIONS rtsp://192.168.0.1:8554/87 RTSP/1.0
CSeq: 553591
Require: RTP2P-v1
Cluster: update
Cluster-Id: 1
Peer-Id: 432
Old-Peer-Id: 430
Client-Port: 8555
RTSP/1.0 200 OK
CSeq: 553591
Peer-Id: 0
RTSP/1.0 301 Moved Permanently
CSeq: 553591
Location: rtsp://192.168.0.4:8555
Cluster-Id: 1
Destination-Peer-Id: 433
Peer-Id: 0
OPTIONS rtsp://192.168.0.4:8555/87 RTSP/1.0
CSeq: 123456
Require: RTP2P-v1
Cluster: join_bcl
Peer-Id: 432
Client-Port: 8555
Cluster-Id: 1
RTSP/1.0 200 OK
CSeq: 123456
Content-Type: text/xml
Content-Length: 315
Peer-Id: 433
<cluster clusterId=“1”>
<clusterLeader peerId=“433” ipAddress=“192.168.0.4” port=“8555” />
<bclList>
<peer peerId=“432” ipAddress=“192.168.0.3” port=“8555” />
</bclList>
<neighborList>
<cluster clusterId=“0”>
<clusterLeader peerId=“703” ipAddress=“192.168.0.14” port=“8555” />
</cluster>
</neighbor List>
</cluster>

In an example embodiment, a peer 110 realizing that CL 111 is not available may try to couple to BCLs in the same cluster. If a BCL has replaced the old CL, the replacing BCL may respond with a 200 OK message. If the BCL did not replace the CL, the BCL may send a 301 Moved Permanently response message with, for example, a ‘Location’ header indicating the location of the last known CL. In case none of BCLs respond to the peer, the peer may send a query to SDS 140 and request a new cluster 130.

A cluster 130 may grow too large to be handled by a single CL 111. In such a situation, the cluster may split into, for example, two separate clusters. In an example embodiment, the CL of the large splitting cluster may assign one of its BCLs to become a new CL in one of the separate clusters. The CL may also redirect a number of peers 110 to the newly assigned CL. In an example embodiment, cluster splitting may be performed using an OPTIONS message with, for example, a ‘split’ tag in the ‘Cluster’ header field. A BCL may respond with a 200 OK message. The BCL may become the CL of the newly created cluster 130. The cluster leader of the large splitting cluster, may send a REDIRECT message to peers 110 assigned to the new cluster. The REDIRECT message may contain the location of the CL of the newly created cluster 130, for example, in a ‘Location’ header field and an ID of the newly created cluster in the ‘Cluster-Id’ header field. Redirected peers 110 may join the new cluster, for example by sending an OPTIONS message to the new cluster leader. Redirected peers 110 may also respond to the splitting CL with a 200 OK message. Example messages sent in the cluster splitting procedure are shown below;

\begin{tiny}
\begin{verbatim}
OPTIONS rtsp://192.168.0.5:41991/105 RTSP/1.0
CSeq: 46264
Require: RTP2P-v1
Cluster: split
Parent: 0
Peer-Id: 498
RTSP/1.0 200 OK
CSeq: 46264
Cluster-Id: 1
Peer-Id: 499
REDIRECT rtsp://192.168.0.6:56097/105 RTSP/1.0
CSeq: 317087
Require: RTP2P-v1
Cluster-Id: 1
Location: rtsp://192.168.0.5:8555
Peer-Id: 498
OPTIONS rtsp://192.168.0.5:8555/105 RTSP/1.0
CSeq: 317081
Require: RTP2P-v1
Cluster: join_peer
Cluster-Id: 1
Client-Port: 8555
Peer-Id: 492
RTSP/1.0 200 OK
CSeq: 317081
Content-Length: 186
Content-Type: text/xml
Peer-Id: 499
<cluster clusterId=“1”>
<peerList version=“2”>
<peer peerId=“490” ipAddress=“192.168.0.7” port=“8555” />
<peer peerId=“499” ipAddress=“192.168.0.5” port=“8555” />
</peerList>
</cluster>
RTSP/1.0 200 OK
CSeq: 317087
Peer-Id: 492

Overlay couplings between CLs 111, of different clusters 130, may be created, for example, by sending an OPTIONS message with a ‘join_neighbor’ tag in the ‘Cluster’ header field and receiving a 200 OK response message. CL to CL coupling may be used to exchange cluster information between neighboring clusters 130. Example OPTIONS and 200 OK messages sent in a CL neighbor joining procedure are shown below;

OPTIONS rtsp://192.168.0.2:8555/128 RTSP/1.0
CSeq: 885735
Cluster: join_neighbor
Cluster-Id: 0
Neighbors-Cluster-Id: 1
Client-Port: 8555
Peer-Id: 703
Require: RTP2P-v1
RTSP/1.0 200 OK
CSeq: 885735
Peer-Id: 702

In an example embodiment, merging of two clusters may be performed, for example, if one, or both, of the two clusters become small, e.g., having a small number of peers 110. If the number of peers in a cluster 130 is small, a peer joining the same cluster 130 may have a very short list of potential source peers. A small number of potential source peers in a cluster 130 may degrade the reliability of the P2P network. For example, one or more of the peers in the cluster 130 may leave the P2P service and therefore fewer resources may be available in the cluster 130 for data transfer between peers. In an example embodiment, in order to initiate a merging of two clusters, a REDIRECT message may be sent to peers in a first cluster. The REDIRECT message may comprise the ID of a second cluster and the location of the CL 111 of the second cluster. Peers in the first cluster may confirm the cluster change by a 200 OK message. Peers in the first cluster may join the second cluster, for example, by sending cluster-join messages, e.g., OPTIONS message, to the CL of the second cluster. Peers in the first cluster may receive a response to the cluster-join messages, e.g., OK 200 message. If a peer in the first cluster does not receive any response from the CL of the second cluster, or it receives a 403 Bad Request message, it may send a 403 Bad Request message to the CL of the first cluster and wait for further instructions. In an example embodiment, the CL of the first cluster may join the second cluster as a BCL. For example, the CL of the first cluster may send a RTSP OPTIONS message with a, e.g., ‘join_bcl’, tag in the ‘Cluster’ header field, to the CL of the second cluster. Example messages sent in a successful cluster merging procedure are shown below;

REDIRECT rtsp://192.168.0.6:41067/111 RTSP/1.0
CSeq: 505272
Require: RTP2P-v1
Cluster-Id: 1
Location: rtsp://192.168.0.3:8555
Peer-Id: 542
OPTIONS rtsp://192.168.0.3:8555/111 RTSP/1.0
CSeq: 505276
Require: RTP2P-v1
Cluster: join_peer
Cluster-Id: 1
Client-Port: 8555
Peer-Id: 546
RTSP/1.0 200 OK
CSeq: 505276
Content-Length: 186
Content-Type: text/xml
Peer-Id: 543
<cluster clusterId=“1”>
<peerList version=“2”>
<peer peerId=“543” ipAddress=“192.168.0.3” port=“8555” />
<peer peerId=“544” ipAddress=“192.168.0.4” port=“8555” />
</peerList>
</cluster>
RTSP/1.0 200 OK
CSeq: 505272
Peer-Id: 546

Overlay network couplings may be maintained using, for example, GET\_PARAMETER and 200 OK messages between peers. GET\_PARAMETER and 200 OK messages may also be used as keep-alive messages. Keep-alive messages between CLs of neighboring clusters may be used to exchange information about neighboring clusters. Keep-alive messages between a CL 111, of a cluster 130, and a BCL 112, in the same cluster, may be used to deliver cluster information from the CL 111 to the BCL 112. Example GET_PARAMETER and 200 OK keep-alive messages sent between peers 110 are shown below;

GET_PARAMETER rtsp://192.168.0.6:8555/87 RTSP/1.0
CSeq: 147040
Require: RTP2P-v1
Peer-Id: 432
RTSP/1.0 200 OK
CSeq: 147040
Peer-Id: 430

In an example embodiment, a peer 110 participating in a P2P service may send an OPTIONS message to the SDS 140, for example, in order to get a list of available services in the P2P network 100. SDS 140 may respond with a 200 OK RTSP message comprising service list information. The 200 OK RTSP message may comprise, for example, only general information of the services in order to decrease the message size. In an example embodiment, the information may be expressed as Extensible Markup Language (XML) fragments. Example messages sent a service list retrieval operation are shown below.

OPTIONS * RTSP/1.0
CSeq: 518941
Require: RTP2P-v1
Content-Length: 23
Content-Type: text/xml
Peer-Id: 431
<search value=“*” />
RTSP/1.0 200 OK
CSeq: 518941
Content-Length: 93
Content-Type: text/xml
Peer-Id: 0
<serviceList>
<service name=“Live Streaming” serviceId=“87” type=“live” />
</serviceList>

In order to join to a P2P service, a peer 110 may retrieve the P2P service information from the SDS 140. In an example embodiment, the peer sends a DESCRIBE message to the SDS 140. SDS 140 may respond with a 200 OK RTSP message. According to an example embodiment, the 200 OK RTSP message may comprise, for example, a partial list of available clusters, in case the number of available clusters is large. If desired, the response message may comprise a full list of available clusters. The response message may use multipart MIME since it may deliver both SDP of the service and the list of available clusters, i.e., in an XML format. Example DESCRIBE and 200 OK messages are shown below;

DESCRIBE rtsp://192.168.0.1:8554/87 RTSP/1.0
CSeq: 518942
Require: RTP2P-v1
Accept: multipart/mixed
Peer-Id: 431
RTSP/1.0 200 OK
CSeq: 518942
Content-Length: 846
Content-Type: multipart/mixed; boundary=“P2P_RTSP”
MIME-version: 1.0
Peer-Id: 0
--P2P_RTSP
Content-Type: application/sdp
Content-Length: 573
v=0
o=430 87 2 IN IP4 192.168.0.2
s=Live Streaming
c=IN IP4 0.0.0.0
t=0 0
a=service-type:live
m=video 8234 RTP/AVP 96
a=rtpmap:96 H264/90000
a=fmtp:96 packetization-mode=1;profile-level-id=42c033;
sprop-parameter-sets=Z0LAM6tBYnf+AXwBBiAAAAMAIAAABJHjBlQ=,aM48gA==;
a=partial-info:stream-id=1;piece-size=400;nb-of-partials=4;
m=audio 3456 RTP/AVP 97
a=rtpmap:97 mpeg4-generic/16000
a=fmtp:97 streamtype=5; profile-level-id=15; mode=AAC-hbr; config=1410;
SizeLength=13;IndexLength=3; IndexDeltaLength=3; Profile=1;
a=partial-info:stream-id=0;piece-size=100;nb-of-partials=1;
--P2P_RTSP
Content-Type: text/xml
Content-Length: 145
<initialClusterList>
<cluster clusterId=“0”>
<clusterLeader peerId=“430” ipAddress=“192.168.0.2” port=“8555” />
</cluster>
</initialClusterList>

According to an example embodiment, the peer may send a GET_PARAMETER message, for example, every CL associated with a cluster in the received list of available clusters. The GET_PARAMETER message may be used for the purpose of RTT calculation. The peer may stop a counter, used to calculate RTT, when a 200 OK RTSP message is received. The peer selects the cluster, for the desired service, associated with the CL from which the 200 OK RTSP message was received. Example GET_PARAMETER and 200 OK messages are shown below;

GET_PARAMETER rtsp://192.168.0.2:8555/87 RTSP/1.0
CSeq: 327728
Require: RTP2P-v1
Peer-Id: 431
RTSP/1.0 200 OK
CSeq: 327728
Peer-Id: 430

In example embodiment, the peer may send an OPTIONS message with a ‘join_peer’ tag in the ‘Cluster’ header field to the CL of the cluster. An initial peer list, of peers in the cluster, may be received in a response message, e.g., a 200 OK RTSP message. In an example embodiment, the initial peer list may be a random subset of the peers in the cluster, for example, if the number of peers in the cluster is large. If desired the initial peer list may comprise all peers in the cluster. The peer may request data from peers listed in the received initial peer list using, for example, a SETUP message. The SETUP message handles configuring UDP port numbers for RTP reception using a ‘Transport’ header field. Requested data may be associated, for example, with a plurality of partial streams. In an example embodiment, few peers may respond by accepting the request for data, for example, less than a target number of requested partial streams. The peer may repeat requesting data, for example, from peers that accepted to deliver the request, until the target number of partial streams is reached. For example, one or more peers, in the received initial peer list, may accept to deliver more than one partial stream per single peer. In an example embodiment, if a peer in the received initial peer list is not responding it may be removed from a internal “known peer” list and no repeated requests are sent to the non-responding peer. The peer may also respond to receiving the requested partial streams, e.g., audio and/or video streams, with a 200 OK RTSP message. Example messages exchanged between the requesting peer, CL and other peers are shown below;

OPTIONS rtsp://192.168.0.2:8555/87 RTSP/1.0
CSeq: 327728
Require: RTP2P-v1
Cluster: join_peer
Cluster-Id: 0
Client-Port: 8555
Peer-Id: 431
RTSP/1.0 200 OK
CSeq: 327728
Content-Length: 128
Content-Type: text/xml
Peer-Id: 430
<cluster clusterId=“0”>
<peerList version=“1”>
<peer peerId=“430” ipAddress=“192.168.0.2” port=“8555” />
</peerList>
</cluster>
SETUP rtsp://192.168.0.2:8555/87/audio/0 RTSP/1.0
CSeq: 327728
Require: RTP2P-v1
Client-Port: 8555
Transport: AVP/RTP;unicast;client_port=8568
Peer-Id: 431
RTSP/1.0 200 OK
CSeq: 327728
Peer-Id: 430
Transport: RTP/AVP;unicast;client_port=8568

In an example embodiment, a peer 110 may leave the P2P network 100 according to one of two types of departures; controlled departure or uncontrolled departure. In a controlled departure a peer may inform CL and other peers, e.g., other peers having data transfer with the leaving peer, about the departure. The peer may send an OPTIONS message with a ‘leave’, tag in the ‘Cluster’ header field to the CL. The peer may also send a TEARDOWN message to the other peers having data transfer with the leaving peer. Thus peers, sending data to the leaving peer, may terminate the RTP session(s) associated with the leaving peer. Also peers, that were receiving data from the leaving peer, may select other peer(s) instead of leaving peer. The TEARDOWN message may also be sent if a peer notices that there is a loop in the data delivery for some partial stream. Example messages associated with a departure of a peer are shown below;

OPTIONS rtsp://192.168.0.2:8555/87 RTSP/1.0
CSeq: 397171
Require: RTP2P-v1
Cluster: leave
Peer-Id: 431
RTSP/1.0 200 OK
CSeq: 397171
Peer-Id: 430
TEARDOWN rtsp://192.168.0.2:8555/87 RTSP/1.0
CSeq: 397177
Require: RTP2P-v1
Peer-Id: 431
RTSP/1.0 200 OK
CSeq: 397177
Peer-Id: 430

In an example embodiment, uncontrolled departure may be noticed, for example by CL and other peers sending data to the leaving peer, if keep-alive messages are not received from the leaving peer within some time interval. A peer receiving data from the leaving peer may notice uncontrolled departure if no data packets are received from the leaving peer within a time interval. The value of the time interval may be defined, e.g., at the receiving peer. The receiving peer may replace the leaving peer with another peer, for example, within a duration associated with a reception buffer in order to avoid interruption.

Names corresponding to header fields, tags, and/or the like, e.g., ‘join_bcl’, ‘join_neighbor’, ‘split’, ‘backup’, ‘Cluster’, and/or the like, are listed as examples. Other names may also be used. These names are not to be interpreted in a restrictive way.

Without in any way limiting the scope, interpretation, or application of the claims appearing below, it is possible that a technical effect of one or more of the example embodiments disclosed herein may be an efficient scalable peer to peer streaming system allowing P2P streaming application with good quality of experience. Another possible technical effect of one or more of the example embodiments disclosed herein may be a reliable real time peer to peer streaming technology. Another technical effect of one or more of the example embodiments disclosed herein may be an effective real time peer to peer streaming system.

Embodiments of the present invention may be implemented in software, hardware, application logic or a combination of software, hardware and application logic. The software, application logic and/or hardware may reside on computer, mobile device or mobile chipset. If desired, part of the software, application logic and/or hardware may reside on, part of the software, application logic and/or hardware may reside on computer, and part of the software, application logic and/or hardware may reside on a mobile device. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a processor; and
memory including computer program code,
the memory and the computer program code configured to, working with the processor, cause the apparatus to perform at least the following:
assign at least one of a plurality of real time transport protocol data units to at least one of at least two peer to peer partial real-time transport protocol streaming sessions, based at least in part on at least one timestamp associated with the at least one of said plurality of real time protocol data units,
said plurality of real time transport protocol data units, being associated with said real time transport protocol media stream.

2. An apparatus according to claim 1, wherein the memory and the computer program code configured to, working with the processor, further cause the apparatus to set up the at least one of at least two peer to peer partial real-time transport protocol streaming sessions.

3. An apparatus according to claim 2, wherein the memory and the computer program code configured to, working with the processor, further cause the apparatus to perform at least one of:
determine the number of said at least two peer to peer partial real-time transport protocol streaming sessions;
transmit information associated with said at least two peer to peer partial real-time transport protocol streaming sessions; and
receive at least one request for at least one of said at least two peer to peer partial real-time transport protocol streaming sessions.

4. An apparatus according to claim 1, wherein the memory and the computer program code configured to, working with the processor, further cause the apparatus to transmit one or more assigned real time transport protocol data units within at least one of the assigned peer to peer partial real time transport protocol streaming sessions.

5. An apparatus according to claim 1, wherein said assigning is further based at least in part on a time interval of fixed duration.

6. An apparatus according to claim 5, wherein said assigning is further based at least in part on:
$$i = round ( \frac{{t}_{RTP} - {t}_{0}}{{T}_{P}} ) mod N ,$$
wherein i being an index of a peer to peer partial real-time transport protocol streaming session, t_{RTP} being a timestamp value associated with the at least one of said plurality of real time protocol data units, T_{P} being time duration of said time intervals of fixed duration, and N being the number of said at least two peer to peer partial real-time transport protocol streaming sessions.

7. An apparatus according to claim 1, wherein at least one data unit of said at least one of a plurality of real time transport protocol data units being assigned to more than one of the at least two peer to peer partial real-time transport protocol streaming sessions.

8. An apparatus according to claim 5, wherein at least one key data unit of said at least one of a plurality of real time transport protocol data units being assigned at the start of said time intervals of fixed duration.

9. A method, comprising:
assigning at least one of a plurality of real time transport protocol data units to at least one of at least two peer to peer partial real time transport protocol streaming sessions, based at least in part on at least one timestamp associated with the at least one of said plurality of real time protocol data units,
said plurality of real time transport protocol data units, being associated with a real time transport protocol media stream.

10. A computer program product comprising a computer-readable medium bearing computer program code embodied therein for use with a computer, the computer program code when executed by a processor cause the performance of the method as in claim 9.

11. An apparatus, comprising:
a processor;
memory including computer program code,
the memory and the computer program code configured to, working with the processor, cause the apparatus to perform at least the following:
receive information related to at least two peer to peer partial real time transport protocol streaming sessions, said at least two peer to peer partial real time transport protocol streaming sessions being associated with a real time transport protocol media stream;
receive at least one of the at least two peer to peer partial real time transport protocol streaming sessions; and
store data associated with said one or more of the at least two peer to peer partial real time transport protocol streaming sessions.

12. An apparatus according to claim 11, wherein the memory and the computer program code configured to, working with the processor, further cause the apparatus to perform at least one of the following:
join a peer to peer network associated with the at least two peer to peer partial real-time transport protocol streaming sessions; and
send at least one request for at least one of the at least two peer to peer partial real time transport protocol streaming sessions.

13. An apparatus according to claim 11, wherein said information comprises at least one of:
total number of the at least two peer to peer partial real-time transport protocol streaming sessions; and
a time duration value, said time duration value being associated with partitioning of said real time transport protocol media stream into said at least two peer to peer partial real-time transport protocol streaming sessions.

14. An apparatus according to claim 11, wherein the memory and the computer program code configured to, working with the processor, further cause the apparatus to perform at least one of:
transmit, to another apparatus, at least one of the received at least one peer to peer partial real time transport protocol streaming sessions;
reconstruct said real time transport protocol media stream based at least in part on the received at least one peer to peer partial real time transport protocol streaming sessions;
consume media content associated with the received one or more peer to peer partial real time transport protocol streaming sessions; and
partition at least one of the received peer to peer partial real time transport protocol streaming sessions into a larger number of new peer to peer partial real time transport protocol streaming sessions.

15. A method, comprising:
receiving information related to at least two peer to peer partial real time transport protocol streaming sessions, said at least two peer to peer partial real time transport protocol streaming sessions being associated with a real time transport protocol media stream; and
receiving at least one of the at least two peer to peer partial real time transport protocol streaming sessions.

16. A method according to claim 15, further comprising at least one of:
joining a peer to peer network associated with the at least two peer to peer partial real time transport protocol streaming sessions; and
sending at least one request for at least one of the at least two peer to peer partial real time transport protocol streaming sessions.

17. A method according to claim 15, wherein said receiving information comprises at least one of:
receiving a total number of the at least two peer to peer partial real-time transport protocol streaming sessions; and
receiving a time duration value, said time duration value being associated with partitioning of said real time transport protocol media stream into said at least two peer to peer partial real-time transport protocol streaming sessions.

18. A method according to claim 15, further comprising at least one of:
transmitting at least one of the received at least one peer to peer partial real time transport protocol streaming sessions;
reconstructing said real time transport protocol media stream based at least in part on the received at least one peer to peer partial real time transport protocol streaming sessions;
consuming media content associated with the received at least one peer to peer partial real time transport protocol streaming sessions; and
partitioning at least one of the received peer to peer partial real time transport protocol streaming sessions into a larger number of new peer to peer partial real time transport protocol streaming sessions.

19. A computer program product comprising a computer-readable medium bearing computer program code embodied therein for use with a computer, the computer program code when executed by a processor cause the performance of the method as in claim 15.
